(19) United States
(12) Patent Application Publication
(10) Pub. No.: US 2018/0252059 A1
(43) Pub. Date: Sep. 6, 2018

(54) Apparatus and Method for Separating Liquid from a Material Comprising a Solid Fraction and a Liquid Fraction

(71) Applicant: Cubility AS, Sandnes (NO)

(72) Inventors: Jan Kristian Vasshus, Sandnes (NO); Arne Malmin, Kleppe (NO)

(73) Assignee: Cubility AS, Sandnes (NO)

(21) Appl. No.: 15/756,682

(22) PCT Filed: Aug. 29, 2016
(86) PCT No.: PCT/NO2016/050178

§ 371 Date: Mar. 1, 2018

(30) Foreign Application Priority Data
Sep. 4, 2015 (NO) 20151136

(51) Int. Cl. E21B 21/06; B01D 11/02; B01D 15/02; B01D 15/18; B65G 15/08

(52) U.S. Cl. CPC E21B 21/065; B01D 11/0246; B65G 15/28; B01D 15/1892; B65G 15/08; B01D 15/02

(57) ABSTRACT

An apparatus and a method is for separating liquid from a material comprising a solid fraction and a liquid fraction. The apparatus has a conveyor belt for bringing the material from a receiving portion to a discharge portion. At least a portion of the conveyor belt is provided with at least one sorption means for absorbing and/or adsorbing liquid from the material while the material is carried between the receiving portion and the discharge portion.

### FIELD

The present invention relates to an apparatus and a method for separating a liquid from a material comprising a solid fraction and a liquid fraction. More particularly, it relates to an apparatus for separating liquid from a material comprising a solid fraction and a liquid fraction, the apparatus comprising a carrier for bringing the material from a receiving portion to a discharge portion, the discharge portion comprising a solids discharge means for discharging the solid fraction from the apparatus and a liquid discharge means for discharging the liquid from the apparatus.

### BACKGROUND

The apparatus according to the invention is particularly useful for separating a liquid fraction of a drilling fluid from a solid fraction of the drilling fluid. By drilling fluid is meant in this document a fluid used in geotechnical engineering to aid the drilling of boreholes into the earth, typically while drilling oil and natural gas wells and on exploration drilling rigs. Drilling fluid is often called drilling mud. Two common categories of drilling fluids are water-based muds (which can be dispersed and non-dispersed) and non-aqueous muds, usually called oil-based mud.

The main functions of drilling fluids include providing hydrostatic pressure to prevent formation fluids from entering into the well bore, keeping the drill bit cool and clean during drilling, carrying out drill cuttings, and suspending the drill cuttings while drilling is paused and when the drilling assembly is brought in and out of the hole.

### SUMMARY

The following description is particularly directed towards cleaning of drill cuttings being brought out of a well in connection with drilling of a petroleum well. However, the invention may also be useful for separating liquid from other types of material wherein it is desirable to separate a liquid fraction of a material from a solid fraction of the material.

When drilling a petroleum well, drilling fluid is continuously circulated between the borehole and the surface to remove drilled particles, also called cuttings, from the drill bit. The cuttings are being carried with the drilling mud to the surface, where the cuttings are separated from the drilling mud. The drilling mud is then recirculated into the well for the drilling work. Due to, among other things, the fact that the drilling mud is expensive, especially OBM (oil based mud), it is desirable for as much of it as possible to be reused. As the drilling mud is recirculated and reused the drilling mud is kept as clean and free of contamination of cuttings and foreign bodies as possible.

Drilling mud is typically cleaned by means of several types of separate equipment incorporated in a process chain. A first equipment in such a process chain may typically be a sieving device. Hitherto, such a sieving device has been a vibrating sieving device, normally called “shale shakers” or “shakers”. However, the present applicant has invented an alternative sieving apparatus which is based on an endless sieving cloth being arranged in an underpressure chamber wherein fluid, both liquid and gases, is separated from the cutting by means of a gas (typically air) being drawn through the sieving cloth. Such an apparatus is sold under the trademark MudCube® and is disclosed for example in Norwegian patent NO 323519 B1. Even by using the MudCube® in the cleaning process, the cuttings being discharged from the apparatus has some residual amount of liquid.

Independent of which sieving device being used and subsequent cleaning devices, the cuttings are transported away from the drilling rig for further processing. For an off-shore drilling rig, the cuttings are loaded into containers, blown or sucked via conduits, or transported via feed screws, to a ship and transported to an onshore receiving plant for further treatment and/or storage.

Due to the residual amount of liquid in the cuttings, the cuttings are bridged together, agglomerated and lumpy. These lumpy cutting tends to clog conduits or screws used for bringing the cutting aboard a ship. A person skilled in the art will know that it may be time consuming to reopen a clogged conduit or screw, and that it eventually may effect a stop in the drilling process.

In order to try to avoid such clogging, it is common to add a liquid, typically drilling mud, in order to reduce the stickiness of the cuttings and thus provide a “fluidized” material being less prone to clogging of the conduit or screw.

This additional fluid negate the cleaning process because the same liquid being reabsorbed by the cuttings and needs to be separated out again from the materials.

However, liquid added to fluidize the cuttings may be expensive. Further, the liquid will add to the weight and thereby the transport and any subsequent cleaning cost.

It is however to be understood that the invention is not limited to cleaning of drill cuttings but is useful for cleaning of contaminated solid particles of such as the kind mentioned above.

The invention has for its object to remedy or to reduce at least one of the drawbacks of the prior art, or at least provide a useful alternative to prior art.

The object is achieved through features, which are specified in the description below and in the claims that follow.

The invention is defined by the independent patent claims. The dependent claims define advantageous embodiments of the invention.

In a first aspect of the present invention, there is provided an apparatus for separating liquid from a material comprising a solid fraction and a liquid fraction, the apparatus comprising a conveyor belt for bringing the material from a receiving portion to a discharge portion. At least a portion of the conveyor belt is provided with at least one sorbent material for absorbing and/or adsorbing liquid from the material while the material is carried between the receiving portion and the discharge portion. The absorption is typically provided by means of capillary forces.

In what follows, the conveyor belt will also be denoted carrier.

Thus, the separation of at least some of the liquid fraction from the solid fraction takes place while the material is being carried from the receiving portion to the discharge portion. The separation is therefore dependent inter alia on the detention time of the material in the carrier, which again is dependent on the length and speed of the carrier, the sorption capability of the sorbent materials and a supply rate of the material to the receiving portion of the apparatus.

When utilized in the petroleum industry, the apparatus may be arranged to receive material directly from the so-called Bell-nipple. A person skilled in the art will appreciate that the Bell-nipple is an enlarged pipe at the top of a casing string that serves as a funnel to guide drilling tools into the top of a well. The Bell-nipple is usually fitted with a side outlet to permit drilling fluids to flow back to the surface mud treating equipment through another inclined pipe called a flowline.

However, the apparatus is particularly suitable to be arranged in series with a sieving device so that the receiving portion of the apparatus receives solid material discharged from the sieving device. The sieving device may be a shaker or the above-mentioned “MudCube®”.

A person skilled in the art will appreciate that a solids material separated by means of a sieving device, will contain some residual liquid adhered to the material.

Arranging the apparatus of the present invention after a sieving apparatus is thus particularly suitable for separating liquid adsorbed to the material, i.e. liquid clinging to the surface of solid particles of the material.

In one embodiment, the apparatus in accordance with the present invention is arranged in series between a sieving apparatus and an apparatus suitable for separating liquid absorbed by the material. An apparatus suitable for separating liquid absorbed by the material is disclosed in the publication WO 2012/050456 A1 to the present applicant. Such an apparatus is sold under the trademark “CutCube®”. However, other known apparatuses may also be used for separating liquid absorbed by the material.

Independent of which type of apparatus being utilized for any separation of liquid absorbed and adsorbed by the material, the solid fraction of the material discharged from the apparatus in accordance with the present invention may be fed directly into an apparatus for separating liquid absorbed and adsorbed by the material, or to a depot receiving the material discharged from the apparatus in accordance with the present invention.

The discharge portion of the apparatus in accordance with the present invention may comprise a solids discharge means for discharging the solid fraction of the material from the apparatus and a liquid discharge means for discharging the liquid fraction of the material from the apparatus. The solids discharging means may be arranged closer to the receiving portion than the liquid discharge means, so that the solid fraction is discharged before the liquid fraction is discharged. This has the effect that the absorbent is substantially free from solid fraction of the material when subject to discharging, and thereby avoiding liquid again being mixed with the solid material.

In one embodiment, the carrier may be made of an absorbent material such as a material comprising cellular rubber or other suitable materials such as polypropylene absorbent mat, synthetic fibers (for example Ultra-X-Tex materials commercially available from Ultratech International, Inc). Preferably, the carrier may comprise a liquid tight portion preventing liquid absorbed by the carrier to leak through the carrier prior to discharging the liquid from the carrier.

The carrier may comprise portions having different absorption/adsorption characteristics as will be discussed below.

Alternatively, or additionally, to the carrier itself having liquid sorption capability, the carrier may be provided with an inlay of sorption means arranged on the carrier receiving the material. The sorption inlay may extend along at least a portion of the carrier such that the carrier supports the sorption inlay at least between the receiving portion and discharge portion of the apparatus, and such that at least a portion of the material received by the carrier is resting on the sorption inlay. Thus, at least one of the sorption means may be an inlay arranged on the carrier, the inlay extending along at least a portion of the carrier.

Providing the carrier with an inlay of sorption means has several advantages. The sorption means inlay may be detachably connected to the carrier. A detachable sorption means inlay may be replaced if sorption properties of the inlay is reduced due to wear thereof, without having to replace the carrier itself. Further, the carrier may be adapted to a particular use, for example change of properties of the material supplied to the apparatus, without having to replace the carrier itself. Still further, the carrier may be provided with two or more sorption means inlays having different absorption or adsorption characteristics as will be discussed below. If the carrier itself has liquid absorbing or adsorbing property, a sorption inlay may have a different absorption or adsorption characteristic(s) of the inlay(s) than that of the carrier.

A sorption means inlay may be connected to the carrier by any suitable means, such as for example, but not limited to, hook and loop fasteners, often referred to as Velcro®, snap-fasteners, a zip or similar fastening means.

In an alternative embodiment, the sorption means inlay may be arranged movably with respect to the carrier. This allows the sorption means inlay to rotate at a slightly different speed than the carrier and allows for the inlay having a longer travelling path than the carrier itself.

The conveyor belt may be a flexible conveyor belt arranged to be moved around at least two turning rollers. In one embodiment, at least one of the rollers is provided with a driving means for rotating the rollers and thus moving the conveyor belt.

In one embodiment, each of the rollers is connected to an end portion of the conveyor belt. In such an embodiment, the conveyor belt is reciprocating by winding it onto one of the rollers while at the same time un-winding the conveyor belt from the other of the roller. Such an embodiment may require two sets of solid material and liquid material discharge means. Further, a portion of the conveyor belt cannot be utilised for obvious reasons.

In a preferred embodiment, the rollers are spaced-apart turning rollers arranged to carry at least a portion of an endless conveyor belt. An endless belt may be rotated in one direction only so that only one solid discharge means and only one liquid discharge means may be required. Further, the whole length of an endless conveyor belt is fully utilised. Additionally, the conveyor belt may be carried by means of a supporting structure of the type disclosed in WO 2013/143551 A1.

The apparatus may be provided with guiding means adapted to lift side portions of the conveyor belt upwards from the receiving portion and towards the discharge portion to form a U- or V-like shape. In one embodiment, the apparatus is provided with guiding means adapted to lift side portions of the conveyor belt upwards from the receiving portion and towards the discharge portion so that the material is carried from the receiving portion towards the solids discharge portion by means of a pouch-like carrier. A guiding means suitable for the apparatus in accordance with the present invention is disclosed in for example WO 2013/143551 as mentioned above and will not be discussed in any further details herein.

The advantage of providing a pouch-like carrier is that it can be substantially closed after having received the material at the receiving portion and until the material is being discharged, thereby at least reducing emission of any potentially hazardous gases from the material while being transported.

The solids discharge means may be the roller(s) receiving the conveyor belt carrying the solid fraction and the liquid fraction of the material. The solid fraction may be discharged by means of redirecting the conveyor belt by means of the roller. Thus, the solid fraction may be discharged by means of gravity and/or centrifugal forces, i.e. the solid fraction falling off the conveyor belt when the belt turns at, or alternatively are winded onto, a roller. The solid fraction of the material may typically be discharged to a depot for storing the material prior to further processing and/or transport to a distant depot.

Alternatively, the solids discharge means may be a shovel device being in contact with the portion of the conveyor belt and/or sorption means inlay carrying the solid fractions of the material. In order not to compress the conveyor belt and/ or the inlay to such an extent that the liquid absorbed or adsorbed by the sorption means being freed from sorption means, the shovel is arranged substantially complementary to a surface of the conveyor belt/inlay carrying the solid particles.

In still another alternative, the solids discharge means may be a diverter diverting the solid fraction off the conveyor belt and/or inlay. In this alternative, the diverter is arranged in a portion where the conveyor belt and/or inlay is/are “flat”, i.e. not having a pouch-like form. In one embodiment, the diverter may be a plate element. In another embodiment, the diverter may be a rotating brush. Independent of being a plate element or a rotating brush, a longitudinal axis of the diverter is arranged non-parallel with a moving direction of the conveyor belt. As for the shovel, a diverter touches only a surface of the conveyor belt and/or inlay carrying the solid particles.

The liquid discharge means may be a squeezing device adapted to compress the sorption means, independently of the sorption means being the carrier itself or an inlay connected to the carrier, so that an amount of the liquid absorbed and/or by the squeezable sorption means is removed from the sorption means. The liquid being removed from the sorption means may be communicated into a collecting means such as for example a vessel or tank. The receiving means may be in fluid communication with a liquid processing apparatus known per se, and/or with a conduit in communication with for example a drilling mud receptacle.

Alternatively or additionally to the squeezing device, the liquid discharge means may comprise a gas jetting means or a gas suction means, so that liquid is blown or sucked out of the material.

Preferably, the liquid discharge means may be arranged at a portion of the conveyor belt wherein the sorption means faces towards a base of the apparatus. Thus, in the position of use, the sorption means may face downwards at the liquid discharge means. Thereby, the liquid squeezed and/or blown or sucked from the sorption means may be led into a collection means by gravity or underpressure, respectively.

In one embodiment at least one of the turning rollers forms part of the liquid discharge means. In such an embodiment, the discharge means preferably comprises a roller contra rotating with respect to the turning roller and being biased towards the carrier. Alternatively, the discharge means may be a scraper or similar means being biased towards the carrier to compress the sorption means in order to squeeze or compress the sorption means and thereby removing at least a portion of the liquid from the sorption means.

As mentioned above, the liquid discharge means may be a gas flowing through or towards the sorption means for scouring or flushing liquid from the sorption means. The gas may typically be air jetted towards or air sucked from the sorption means. The air may be sucked for example by means of at least one suction nozzle being directed towards the sorption means. Such a suction nozzle may be in fluid communication with vacuum-generating device via a pipe arrangement. A suitable apparatus for providing suction is disclosed NO 323519 B1.

Depending on the supply rate of material into the receiving portion of the apparatus, a speed and length of the carrier, and the configuration of the carrier and sorption means, some of the material may not be in contact with the sorption means. This may result in a less effective separation apparatus. In order to expose as much as possible of the material to the sorption means, the apparatus may be further provided with one or more agitation means suitable for “stirring” or agitating the material while being carried between the receiving portion and the solids discharge means, i.e. while being in the carrier. One example of a suitable agitation means is a turnwrest plough arranged within a portion of the carrier between the receiving portion and the discharge portion. If only one agitation means is used, it may typically be arranged for example about half way between the receiving portion and discharge portion for solids material. Alternatively, or additionally, “stirring” of the material may be provided by means of unloading the material from one portion of the carrier and reloading the material to another portion of the carrier. An example of such an additional or alternative “stirring” is further discussed below when describing FIGS. 4a and 4b.

The sorption means may comprise at least two sorption means having different sorption characteristics in order to separate liquids being absorbed and/or adsorbed by the solid material, or any liquid, such as a washing agent, added to the material in order to facilitate separation of for example an oil from the solid material. In one embodiment, one of the sorption means may be hydrophilic, alternatively hydrophobic, while another one of the sorption means may be oleophilic, alternatively oleophobic, or any combinations thereof. The sorption means may be adapted to the desired absorption or adsorption characteristics. Suitable sorption means are commercially available in the market, for example from New Pig® Corporation.

The at least two sorption means, independent of being integrated or forming part of the carrier itself or being inlays attached to the carrier, may be arranged in parallel. In one embodiment each of the at least two sorption means may be provided with separate squeezing means and/or blowing or suction means. The liquid removed from each of the at least two sorption means may be communicated into separate collection means as previously mentioned.

The apparatus may be provided with a sensor means for monitoring the condition of the sorption means. The sensor means may be a weighing device arranged for comparing a weight of a portion of the carrier at certain intervals. Alternatively, or additionally, the sensor means may be a shape-detecting device comparing a form or volume of a portion of the sorption means at certain intervals. The sensor device is typically arranged to compare a “dry” weight and/or form of a “dry” sorption means measured in one cycle and compare the weight and/or form with the dry weight and/or form of a previous cycle or a predetermined value. The sensor device may be configured to give a warning to an operator, i.e. by means of a signal, if a difference in weight and/or form deviates from a preset value.

A second aspect of the present invention regards use of a sorption means for separating a liquid fraction of a drilling fluid from a solid fraction of the drilling fluid.

In accordance with a third aspect of the present invention there is provided a method for separating liquid from a material comprising a solid fraction and a liquid fraction by means of an apparatus comprising a conveyor belt for bringing the material from a receiving portion to a discharge portion, wherein the method comprises:
supplying the material to the conveyor belt comprising a sorption means for absorbing and/or adsorbing liquid;
bringing the material towards a solid fraction discharge means;
discharging the solid fraction; and then
bringing the conveyor belt comprising the sorption means to a liquid discharge means and discharge at least a portion of the liquid absorbed and/or adsorbed from the material.

The material may be drilling fluid used in the petroleum industry.

### BRIEF DESCRIPTION OF THE DRAWINGS

In the following is described examples of preferred embodiments illustrated in the ac- companying drawings, wherein:

FIG. 1 shows a principal sketch of the apparatus in accordance with the present invention shown in perspective, wherein the apparatus comprises and endless conveyor belt;

FIG. 2a shows a side view of the apparatus in FIG. 1;

FIG. 2b shows in larger scale detail B in FIG. 2a;

FIGS. 3a and 3b show in larger scale a detail of a portion of two embodiments of the discharge means of the apparatus in FIG. 1;

FIGS. 4a and 4b show a portion of the an apparatus provided with an agitation means; and

FIG. 5 shows an alternative embodiment of the apparatus in FIG. 1.

### DETAILED DESCRIPTION OF THE DRAWINGS

In what follows, positional indications such as for example “above”, “below”, “right” and “left”, refer to the position shown in the figures.

Same or corresponding elements are indicated by same reference numerals in the different figures.

A person skilled in the art will understand that the figures are principle drawings only and that relative proportions between individual elements may be distorted.

In the figures, reference number 1 shows an apparatus in accordance with the present invention. The apparatus 1 comprises a conveyor belt or carrier 3 for bringing a material M from a receiving portion 5 to a discharge portion 7.

The carrier 3 is provided with a compressible or squeezable sorption means 9 adapted to absorb and/or adsorb liquid from the material M while being carried between the receiving portion 5 and the discharge portion 7.

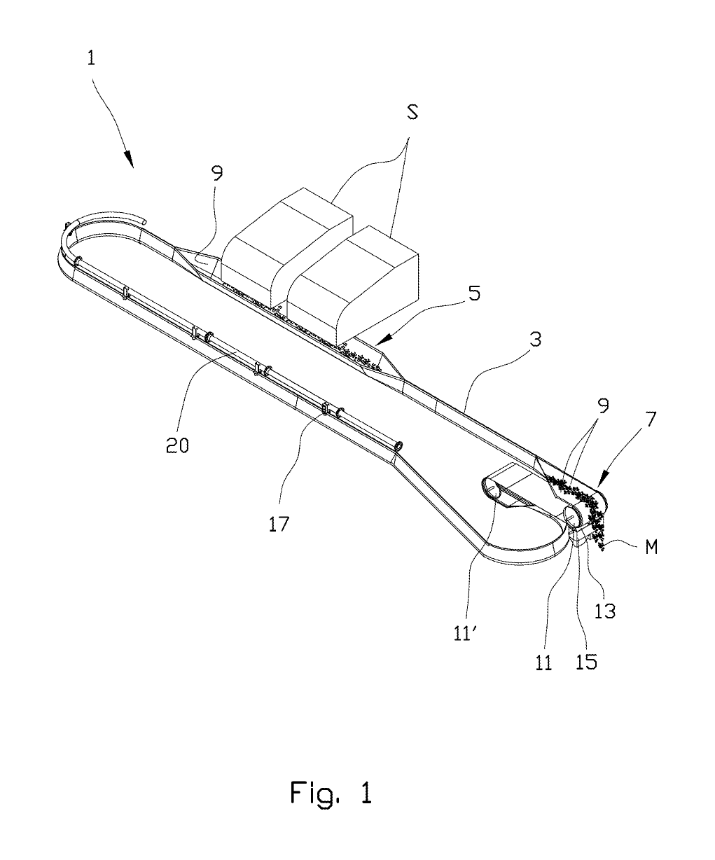

In FIG. 1 material M is supplied to a receiving portion 5 of the apparatus 1 by means of two sieving devices S, here illustrated as MudCube® disclosed for example in Norwegian patent NO 323519 B1. It should be noted that the sieving device may alternatively be a “Shale shaker” as will be known to a person skilled in the art. The sieving devices S are in communication with a well bore (not shown).

A person skilled in the art will appreciate that a sieving device S (two shown) of the MudCube® type, separates a substantial portion of the fluid (liquid and gas) from the solid particles of the drilling mud. However, the solid particles or material M discharged from the sieving devices S and into the receiving portion 5 of the apparatus 1 will still contain some liquid, typically 10-20% by weight. Material discharged from a traditional “shale shaker” may typically have a liquid content of about 50-80% by weight. However, a person skilled in the art will appreciate that the liquid content of a material discharged from a sieving apparatus may vary considerably due to the formation being drilled, any clogging of the sieving element, etc.

One purpose of the apparatus 1 in accordance with the present invention is to further separate liquid from the material M. This is achieved by providing at least a portion of the carrier 3 with at least one sorption means 9 adapted to absorb and/or adsorb liquid from the material while the material M is carried by means of the carrier 3 from the receiving portion 5 to the discharge portion 7. In the embodiment shown, the carrier 3 is a conveyor belt 3.

In FIG. 1, the conveyor belt 3 is of a type known per se, for example a commercially available rubber type belt. The conveyor belt 3 is provided with an inlay 9 of absorbent and/or adsorbent material. The inlay 9 comprises in the embodiment shown, two inlays arranged in parallel in a longitudinal direction of the conveyor belt 3. The two inlays 9 may have the same absorption/adsorption characteristics, or different absorption/adsorption characteristics as mentioned above.

The inlay 9 is detachably connected to the conveyor belt 3 by means of for example a Velcro® or other suitable connecting means. This allows for replacement of the inlay 9 without replacing the conveyor belt 3.

At the receiving portion 5, the conveyor belt 3 has a U- or V-like shape in order to form an open “pouch” capable of holding the material M received from the sieving apparatuses S. At the discharge portion 7, the conveyor belt 3 with its inlays 9, is folded out to form a “flat” belt suitable for being partly rotated around a turning roller 11 as shown.

At the turning roller 11, the conveyor belt 3 with its inlays 9 are redirected and turned upside-down to allow discharging of the material M into for example a container (not shown) or other suitable receiving or transportation means. Thus, in this embodiment the turning roller 11 is a solid discharge means of the apparatus 1.

A secondary turning roller 11′ is arranged after the turning roller 11 (as seen in the moving direction of the carrier 3). The purpose of the secondary roller 11′ is to reorient the carrier or conveyor belt 3 into a position suitable for again receiving the material M from the sieving devices S.

In a prototype of the apparatus 1, an inlay 9 of polypropylene material showed very good results both with regards to absorbing liquid from the material M, and a subsequent removal or “draining” of the liquid from the inlay 9 by means of compression or squeezing of the carrier 3 and the inlay 9. The liquid content of the material M was reduced by about 17% by weight from the receiving portion 5 to the discharge portion 7.

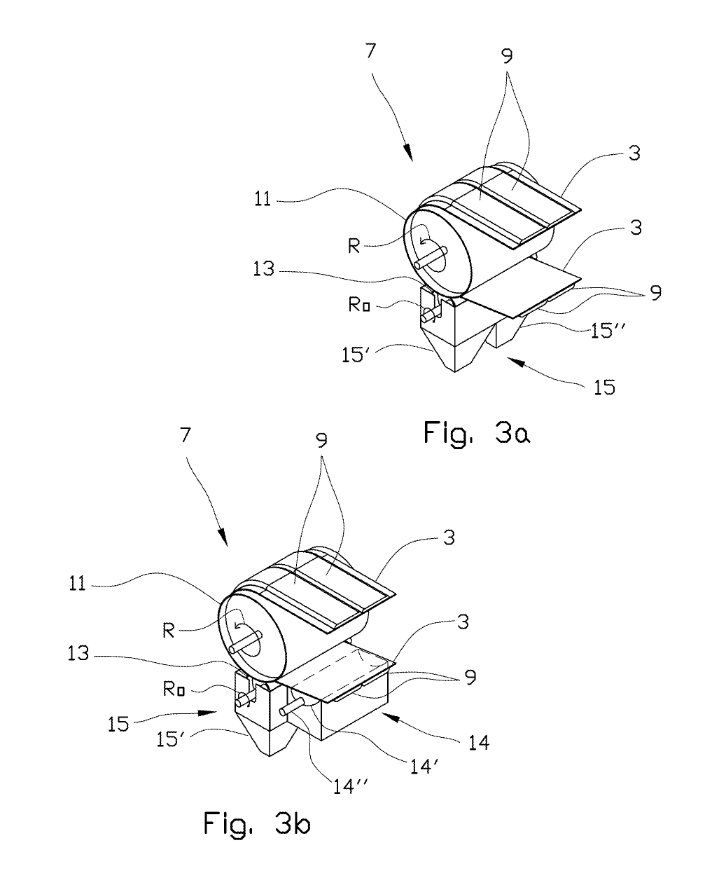

The compression is provided by means of compression roller 13 biased towards a lower portion of the turning roller 11 as best can be seen in FIGS. 3a and 3b which shows the discharge portion 7 of the apparatus 1 in larger scale. The turning roller 11 rotates in a direction as indicated by arrow R in FIG. 3a and FIG. 3b. The rotation R is provided by means of a suitable driving means (not shown) or by means of frictional forces transferred from the carrier 3 if the carrier 3 is driven by driving means arranged at some other suitable location. The compression roller 13 is rotated in an opposite direction Rₒ, either by means of a driving means (not shown) or by means of frictional forces transferred form the carrier 3 and inlays 9.

At the turning roller 11, the material M (see FIG. 1) carried by the carrier 3 and inlays 9 falls off and is collected by a receptacle such as for example a container (not shown). The carrier 3 and inlays 9 are then compressed between the turning roller 11 and compression roller 13, whereby a substantial amount of liquid absorbed by the inlays 9 (and in some embodiments also the carrier 3 itself) is freed and collected by means of a receptacle 15 arranged under the rollers 11, 13 as shown. Thus, in this embodiment the turning roller 11 together with the compression roller 13 provide a liquid discharge means of the apparatus 1.

Seen isolated, and in the moving direction of the carrier 3 and inlays 9, the turning roller 11 forming the solids discharge means is arranged closer to the receiving portion 5 of the apparatus 1 than the turning roller 11 and the compression turning roller 13 which together form the liquid discharge means.

It should be noted that the receptacle 15 shown is typically a receiving means arranged for communicating the liquid into larger container(s) or conduits in communication with such container(s).

In a configuration where the two inlays 9 have different absorbing/adsorbing characteristics as discussed above, it is advantageous if the different liquids are kept substantially separate after the liquids have being freed from the inlays 9. This is achieved by means of dividing the receptacle 15 into two separate sub-receptacles 15′, 15″ as shown in for example FIGS. 3a and 3b.

In FIG. 3b, the discharge means shown in FIG. 3a is further provided with a suction means 14. The suction means 14 is provided with suction nozzle 14′ brought up towards the inlay 9 and carrier 3. The suction nozzle 14′ is provided with a conduit 14″ being in fluid communication with an underpressure generating device (not shown) known per se for example from NO 323519 B1. Upon activating the underpressure generating device, fluid will be evacuated from the suction means 14 and liquid will be sucked from the inlays 9 and carrier 3.

Although FIG. 3b shows a combination of a compression means 11, 13 and a suction means 14, it should be appreciated that the suction means 14 may be a standalone liquid discharge means, i.e. without the compression means.

In an alternative embodiment (not shown) the suction means 14 may comprise two or more separate suctions means configured for separately sucking each of the inlays 9. This allows for keeping liquid absorbed/adsorbed by inlays (9) having different sorption characteristics.

It should be appreciated that a supporting structure runs along the entire length of the carrier 3 apart from at the discharge portion 7 where the carrier is supported by turning rollers 11, 11′. Further, the supporting structure disclosed in detail in the publication WO 2013/143551 A1 is a suitable supporting structure 20 for the present invention.

The sorption means, either being the carrier 3 itself, an inlay 9 or a combination thereof, may deteriorate after some time of operation.

In order to monitor the condition of the sorption means 3, 9, the apparatus 1 may be provided with a sensor means.

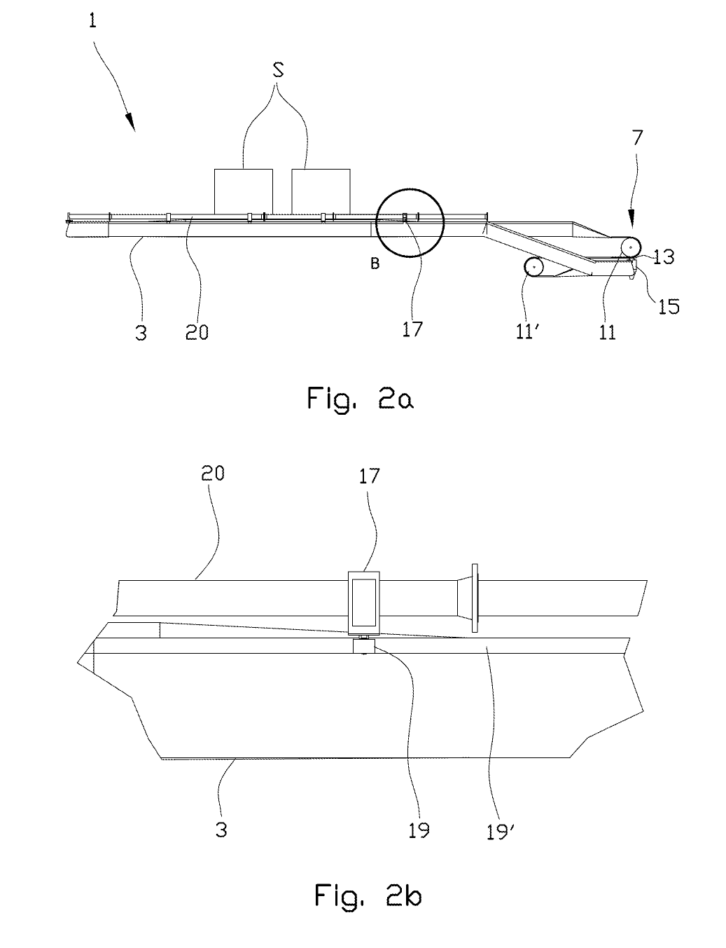

FIGS. 2a and 2b show a sensor means in the form of a weight 17 connecting the carrier 3 to a supporting structure 20 supporting the carrier 3. In the embodiment shown, a lower portion of the weight 17 is provided by a roller 19 being in engagement with a V-belt arrangement 19′ formed in a portion of the carrier 3. The roller/V-belt arrangement is based on the same principle as disclosed in WO 2013/143551 A1.

By measuring the weight of an “empty” carrier 3 at certain intervals, for example once for each travelling round of the carrier 3, and compare the results with for example a predetermined value, a signal may be given to an operator when the weight deviates from the predetermined value. The carrier 3 is “empty” between the discharge portion 7 and the receiving portion 5 of the apparatus 1.

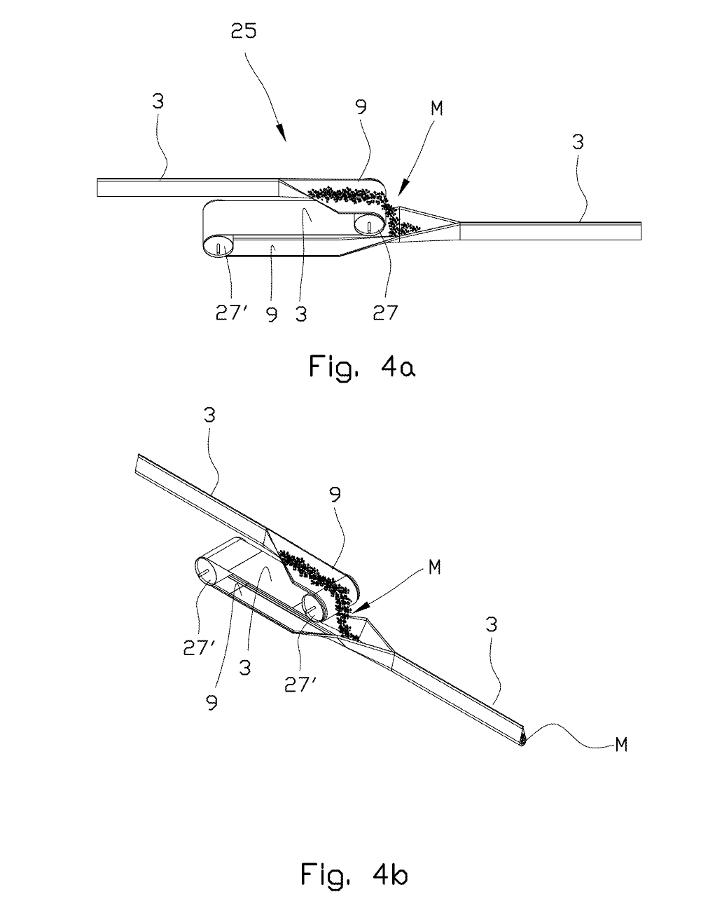

FIGS. 4a and 4b show an agitation means 25 suitable for “stirring” the material M while being carried between the receiving portion 5 and the discharge portion 7 of the apparatus 1. The agitation means 25 may for example be arranged about halfway between the receiving portion 5 and the discharge portion 7.

In the embodiment shown, the agitation means 25 comprises two turning rollers, a first roller 27 and a second roller 27′. When the material passes the first turning roller 27, the material M will fall or, depending on the speed of the carrier 3 and type of material, be slung off the carrier 3. However, the second turning roller 27′ redirects the carrier 3 such that the carrier 3 will again catch the material M being discharged by means of the first turning roller 27. Thus, an agitation means 25 forming part of the apparatus 1 shown in FIG. 1 as suggested above, will provide a “stirring” motion of the material M while being moved from the receiving portion 5 to the discharge portion of the apparatus 1 shown in FIG. 1. The first and second turning rollers 27, 27′ will be additional to the turning rollers 11, 13 shown in for example FIG. 1.

Alternatively or additionally to the agitation means 25 shown in FIGS. 4a and 4b, agitation may also be provided by means of a scraper or plough device (not shown) being in contact with the material M while being transported from the receiving portion 5 to the discharge portion 7. Such a scraper or plough may typically extend from the support structure S into a partly open pouch similar to the open pouch at the receiving portion 5 shown in FIG. 1.

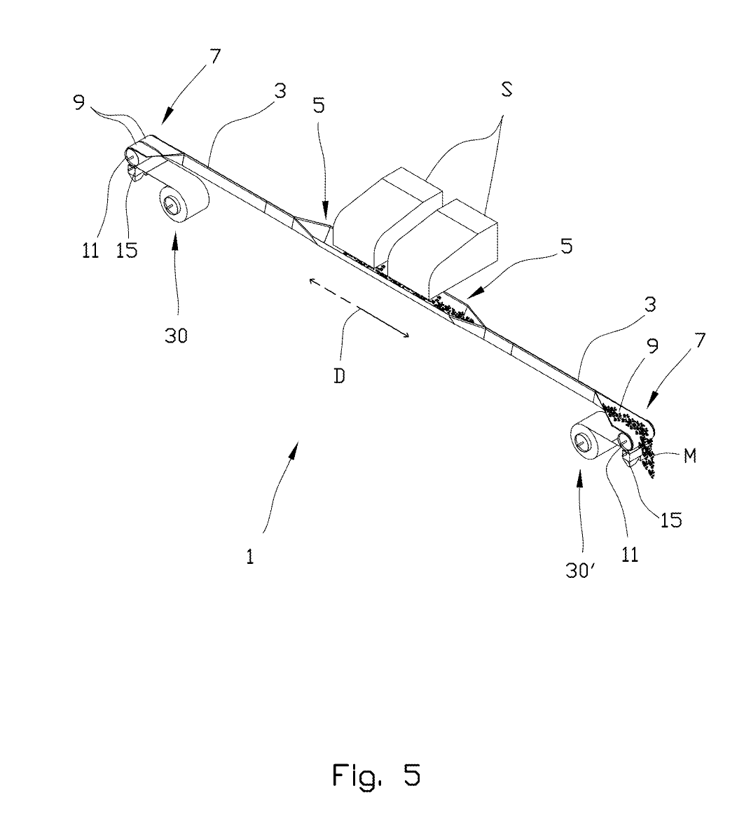

FIG. 5 shown an alternative apparatus 1 in accordance with the present invention. A main difference from the apparatus 1 shown in FIG. 1, is that the carrier or conveyor belt 3 is not endless. Other parts of the apparatus 1 shown in FIG. 5 are similar to the apparatus shown and described with regards to FIG. 1 and will thus not be repeated.

The apparatus 1 in FIG. 5 is provided with a carrier 3 that is connected to a winding drum 30, 30′ at each of its two end portions. In operation, the carrier 3 is reciprocating (indicated by double arrow D) by winding it onto one of the winding drums 30, 30′ while at the same time un-winding the carrier 3 from the other of the winding drums 30, 30′. The reciprocating frequency, i.e. how often change of direction has to take place, depends inter alia on the capacity of the carrying capacity of the drums 30, 30′, length and speed of the carrier 3. In the embodiment shown, the apparatus 1 is provided with two discharge portions 7, one at each winding drum 30, 30′.

In FIG. 5, the carrier 3 is shown moving from left to right, i.e. un-winding from the left winding drum 30 onto the right winding drum 30′.

Although not shown, the carrier 3 in FIG. 5 is connected to a support structure of the same type as partly shown and described concerning FIG. 1.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. An apparatus for separating liquid from a material comprising a solid fraction and a liquid fraction, the apparatus comprising: a conveyor belt for bringing the material from a receiving portion to a discharge portion, wherein at least a portion of the conveyor belt is provided with at least one sorption means for at least one of absorbing and adsorbing liquid from the material while the material is carried between the receiving portion and the discharge portion.

2. The apparatus in accordance with claim 1, wherein the discharge portion of the apparatus comprises a solids discharge means for discharging the solid fraction of the material from the apparatus and a liquid discharge means for discharging the liquid fraction of the material from the apparatus, and wherein the solids discharging means is arranged closer to the receiving portion than the liquid discharge means, so that the solid fraction is discharged before the liquid fraction is discharged.

3. The apparatus according to claim 1, wherein the at least one sorption means is an inlay arranged on the conveyor belt, the inlay extending along at least a portion of the conveyor belt.

4. The apparatus according to claim 1, wherein the conveyor belt is a flexible conveyor belt arranged to be moved around at least two turning rollers.

5. The apparatus according to claim 4, wherein the conveyor belt is endless.

6. The apparatus according to claim 4, further comprising guiding means adapted to lift side portions of the conveyor belt upwards from the receiving portion and towards the discharge portion, so that the conveyor belt is a pouch-like conveyor belt and the material is carried from the receiving portion towards the solids discharge portion the pouch-like conveyor belt.

7. The apparatus according to claim 4, wherein the solids discharge means is a roller of the at least two turning rollers which receives the conveyor belt carrying the solid fraction and the liquid fraction of the material, the solid fraction being discharged by redirecting the conveyor belt via the roller.

8. The apparatus according to claim 1, further comprising a liquid discharge means for discharging the liquid fraction of the material from the apparatus, wherein the liquid discharge means is a squeezing device adapted to compress the sorption means, so that an amount of the liquid absorbed by the sorption means is removed from the sorption means.

9. The apparatus according to claim 1, further comprising a liquid discharge means for discharging the liquid fraction of the material from the apparatus, wherein the liquid discharge means comprises a gas jetting means or a gas suction means.

10. The apparatus according to claim 8, further comprising a liquid discharge means for discharging the liquid fraction of the material from the apparatus, wherein the liquid discharge means is arranged at a portion of the conveyor belt wherein the sorption means faces towards a base of the apparatus.

11. The apparatus according to claim 8, wherein the conveyor belt is arranged to be moved around at least two turning rollers, and wherein one of the at least two turning rollers forms part of the liquid discharge means.

12. The apparatus according to claim 1, wherein the apparatus further comprises an agitation means for agitating the material while being carried between the receiving portion and the solids discharge means.

13. The apparatus according to claim 1, wherein the sorption means comprises at least two sorption means having different sorption characteristics.

14. The apparatus according to claim 13, wherein the at least two sorption means are arranged in parallel.

15. The apparatus according to claim 13, wherein the liquid removed from each of the at least two sorption means is communicated into separate collection means.

16. The apparatus according to claim 3, wherein the inlay is detachably connected to the carrier.

17. The apparatus according to claim 1, further comprising a sensor means for monitoring thea condition of the sorption means.

18. (canceled)

19. A method for separating liquid from a material comprising a solid fraction and a liquid fraction via an apparatus comprising a conveyor belt for bringing the material from a receiving portion to a discharge portion, the method comprising:
supplying the material to the conveyor belt, wherein the conveyor belt comprises a sorption means for at least one of absorbing and adsorbing liquid;
bringing the material towards a solid fraction discharge means;
discharging the solid fraction; and then
bringing the conveyor belt comprising the sorption means to a liquid discharge means, and discharging at least a portion of the liquid absorbed and/or adsorbed from the material.

20. The method in accordance with claim 19, wherein the conveyor belt is endless.

21. The method in accordance with claim 18, wherein the material is drilling fluid.

22. The method in accordance with claim 19, wherein the material is drilling fluid.
